(19) United States
(12) Patent Application Publication
(10) Pub. No.: US 2022/0297150 A1
(43) Pub. Date: Sep. 22, 2022

(54) INGROUND ANCHOR FOR WATER SUPPLY LINES AND SPRINKLERS

(71) Applicant: William J. Keegan, Oakdale, CA (US)

(72) Inventor: William J. Keegan, Oakdale, CA (US)

(21) Appl. No.: 17/207,876

(22) Filed: Mar. 22, 2021

(51) Int. Cl. B05B 15/622; A01G 25/02

(52) U.S. Cl. CPC B05B 15/622; A01G 25/02

(57) ABSTRACT

A watering system that includes a main water hose, a plurality of water supply lines, a plurality of sprinkler heads, and a plurality of inground anchors each including a shaft having clips thereon for releasably attaching the water supply lines and or a sprinkler head thereto and a spike extending therefrom including wing spikes and ground retention members extending therefrom for securely engaging the ground to thereby resist removal or rotation with respect to the ground.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of watering systems including a plurality of water supply lines and sprinklers along with a plurality of inground anchors for releasably attaching the water supply lines and or a sprinkler thereto.

### 2. Description of the Related Art

Existing watering systems that include a plurality of water supply lines and sprinklers incorporate inground anchors to hold water supply lines between sprinklers. However, these previous inground anchors do not hold the water supply lines securely enough and become loose and break away from the anchors resulting in broken or separated water supply lines and water leaks. Therefore, a need exists to devise an improved inground anchor for watering systems with features incorporated therein to overcome these deficiencies.

### BRIEF SUMMARY OF THE INVENTION

In view of the foregoing disadvantages inherent in the known art, the present invention provides an improved inground anchor for water supply lines and sprinklers. The general purpose of the present invention, which will be described subsequently in greater detail, is to provide a watering system that includes a plurality of water supply lines and sprinklers along with a plurality of inground anchors each including a shaft having clips thereon for releasably attaching the water supply lines and or a sprinklers thereto and a spike extending therefrom including wing spikes and ground retention members extending therefrom for securely engaging the ground to thereby resist removal or rotation with respect to the ground.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments according to the teachings of the present invention.

FIG. 1 shows a perspective view of an inground anchor for water supply lines and sprinklers according to a first embodiment of the present invention.

FIG. 2 shows a perspective view of an inground anchor for water supply lines and sprinklers according to a second embodiment of the present invention.

FIG. 3 shows a perspective view of a series of inground anchors, water supply lines, and sprinklers forming a watering system according to a preferred embodiment of the present invention.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

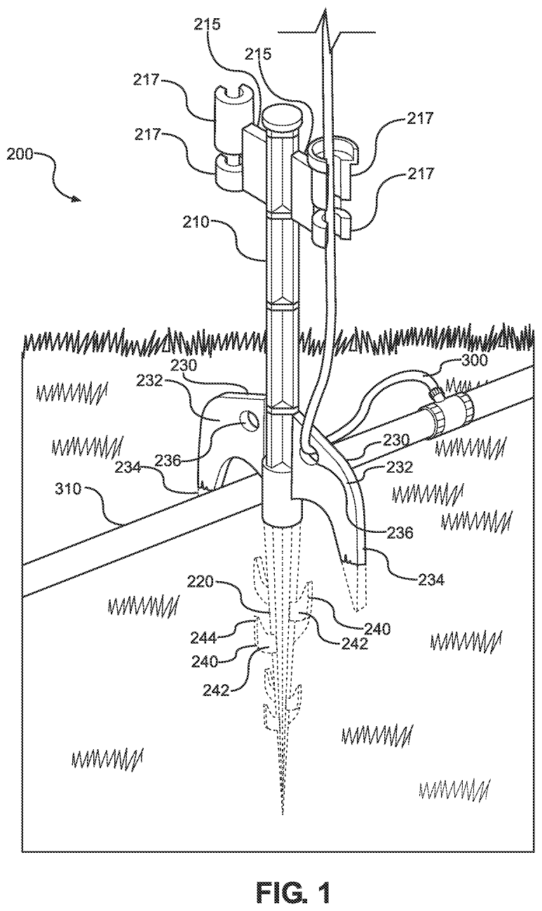

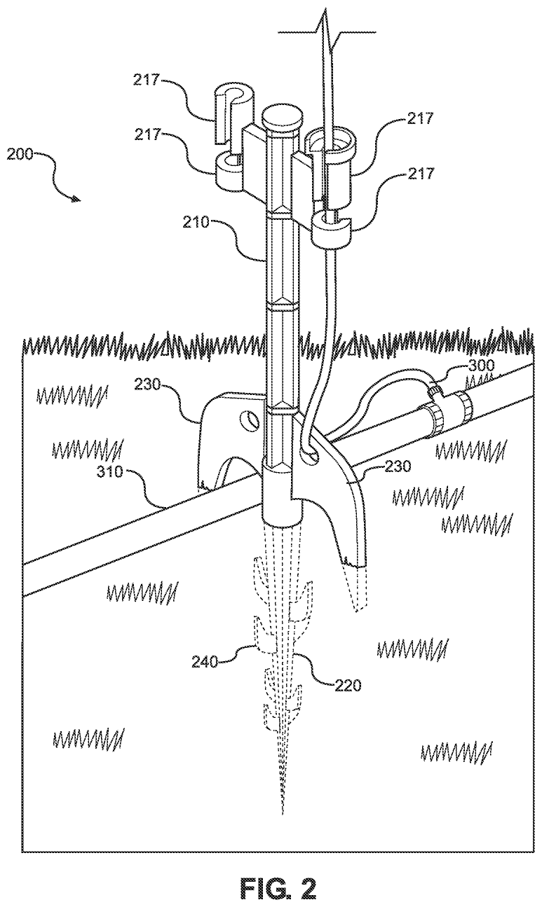

Referring to FIGS. 1-3, the present invention discloses a watering system 100 comprising a plurality of inground anchors 200; a plurality of water supply lines 300; at least one main water hose 310; and a plurality of sprinklers 400. The main feature of the inground anchors each comprise an elongated body including an elongated shaft 210 having a proximal end portion, a middle portion, and a distal end portion, and an elongated spike 220 including a proximal end portion attached to the distal end portion of the elongated shaft, a middle portion, and a distal end portion, wherein the elongated spike is tapered from the proximal end portion to the distal end portion. Each inground anchor 200 further comprises two clips 215, each including at least one semi-cylindrical clip portion 217 adapted to releasably retain one of the plurality of sprinklers 400 or water lines 300 therein, wherein the two clips 217 are attached to opposite sides of the proximal end portion of the elongated body. Each inground anchor 200 further comprises two wing spikes 230, each including a panel portion 232, attached to the distal end portion of the elongated shaft 210, and a downwardly extending tapered ground penetrating portion 234 extending from the panel portion and spaced from the distal end portion of the elongated shaft 210, wherein the two wing spikes 230 are attached to opposite sides of the distal end portion of the elongated body; and at least one ground retention member 240 including a panel portion 242 attached to the middle portion of the elongated spike, and an upwardly extending ground engaging tapered portion 244 extending from the panel portion and is spaced from the middle portion of the elongated spike.

The plurality of inground anchors 200 are each adapted such that when inserted into the ground the elongated spike 220, the at least one ground retention member 240, and the ground penetrating portions 234 of the two wing spikes 230 are within and engage the ground to thereby resist removal therefrom or rotation thereto.

A chosen number of the sprinklers 400 can be respectively attached to chosen ones of the semi-cylindrical clip portions 217 of the clips 215 of the plurality of inground anchors 200, and the plurality of water supply lines 300 can be attached between the at least one main water hose 310 and the plurality of sprinklers 400 and held in place via respective inground anchors 200, to thereby form the watering system 100.

In the preferred embodiment, the two clips 215 are oriented 180 degrees from one another upon the proximal end portion of the elongated body and each include two spaced semi-cylindrical clip portions 217. In a first embodiment, the two semi-cylindrical clip portions 217 are in alignment to one another and adapted such that when a water supply line is attached therebetween the two semi-cylindrical clip portions contact the same side of the water supply line 300. In a second embodiment, the two semi-cylindrical clip portions 217 are oriented 180 degrees from one another and adapted such that when a water supply line is attached therebetween the two semi-cylindrical clip portions contact opposite sides of the water supply line 300 thereby more securely holding the water supply line 300 therebetween.

The panel portion 232 of each of the two wing spikes 230 includes at least one aperture 236 therethrough adapted to allow a water supply line 300 to pass therethrough and extend upwardly to a respective one of the two clips 215.

In the preferred embodiment, there are at least two ground retention members 240 spaced from one another and oriented 180 degrees to one another and form a pair of ground retention members. There can be at least two pairs of ground retention members spaced from one another along a length of the middle portion of the spike and be oriented 90 degrees to one another in an alternating pattern.

The at least one semi-cylindrical clip portion 217 of both of the two clips have an inner diameter chosen from a group of dimensions consisting of ½ inch, ¾ inch, and 1 inch; and wherein the at least one aperture 236 of said panel portion 232 of each of the two wing spikes 230 has an inner diameter chosen from a group of dimensions consisting of ½ inch, ¾ inch, and 1 inch. In following, the outer diameter of the at least one water supply line 300 is chosen from a group of dimensions consisting of ½ inch, ¾ inch, and 1 inch to match the inner diameters of the two clips 215 and the apertures 236 of the panel portions of the two wing spikes.

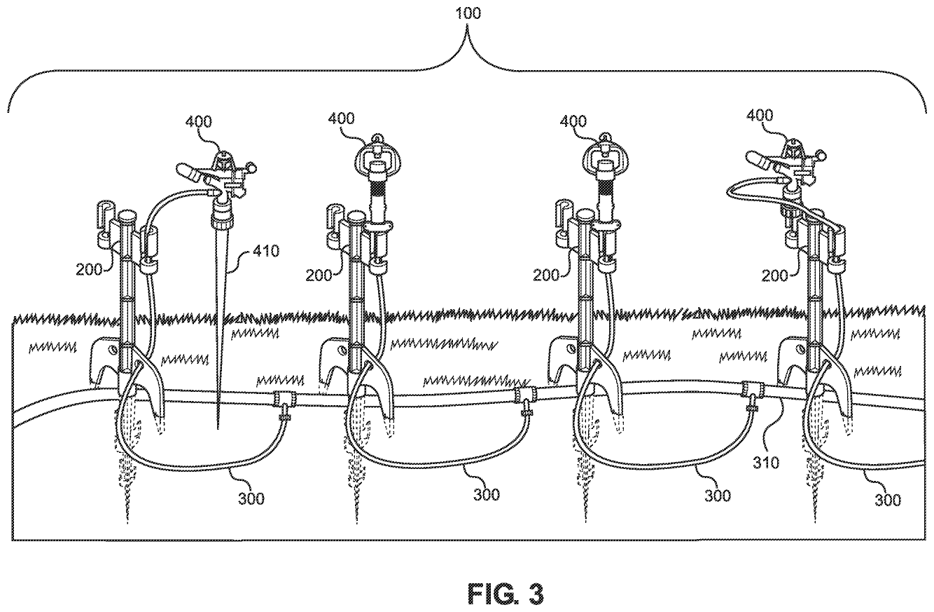

As shown in FIG. 3, the inground anchors 200 can be used to hold the water supply lines 300 adjacent to and then attached to a sprinkler 400 having its own inground spike portion 410, or the clips 215 of the inground anchors 200 can also be used to hold a sprinkler 400 thereon and also hold the water supply lines 300 being attached to the sprinkler 400. Besides a friction fit between the clips and sprinkler heads, means for holding the sprinkler head more securely to the clips may include screw threads or ridges or any variation thereof.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

What is claimed is:

1. An inground anchor for sprinklers and water supply lines, comprising:
an elongated body including:
an elongated shaft including:
a proximal end portion;
a middle portion; and
a distal end portion; and
an elongated spike including:
a proximal end portion;
wherein said proximal end portion is attached to said distal end portion of said elongated shaft;
a middle portion; and
a distal end portion;
wherein said elongated spike is tapered from said proximal end portion to said distal end portion;
two clips, each including:
at least one semi-cylindrical clip portion;
wherein said at least one semi-cylindrical clip portion is adapted to releasably retain a sprinkler or water line therein;
wherein said two clips are attached to opposite sides of said proximal end portion of said elongated body;
two wing spikes, each including:
a panel portion;
wherein said panel portion is attached to said distal end portion of said elongated shaft; and
a downwardly extending tapered ground penetrating portion;
wherein said downwardly extending tapered ground penetrating portion extends from said panel portion and is spaced from said distal end portion of said elongated shaft;
wherein said two wing spikes are attached to opposite sides of said distal end portion of said elongated body; and
at least one ground retention member including:
a panel portion;
wherein said panel portion is attached to said middle portion of said elongated spike; and
an upwardly extending ground engaging tapered portion;
wherein said upwardly extending ground engaging tapered portion extends from said panel portion and is spaced from said middle portion of said elongated spike;
wherein said inground anchor is adapted such that when inserted into the ground said elongated spike, said at least one ground retention member, and said ground penetrating portions of said two wing spikes are within and engage the ground to thereby resist removal therefrom or rotation thereto.

2. The inground anchor of claim 1, wherein said two clips are oriented 180 degrees from one another upon said proximal end portion of said elongated body.

3. The inground anchor of claim 1, wherein each of said two clips includes two spaced semi-cylindrical clip portions.

4. The inground anchor of claim 3, wherein said two semi-cylindrical clip portions of each of said two clips are in alignment one another and adapted such that when a water supply line is attached therebetween said two semi-cylindrical clip portions contact the same side of said water supply line.

5. The inground anchor of claim 3, wherein said two semi-cylindrical clip portions of each of said two clips are oriented 180 degrees from one another and adapted such that when a water supply line is attached therebetween said two semi-cylindrical clip portions contact opposite sides of said water supply line.

6. The inground anchor of claim 1, wherein said panel portion of each of said two wing spikes includes at least one aperture therethrough adapted to allow a water supply line to pass therethrough and extend upwardly to a respective one of said two clips.

7. The inground anchor of claim 1, wherein there are at least two ground retention members spaced from one another.

8. The inground anchor of claim 7, wherein there are two ground retention members spaced from one another and oriented 180 degrees to one another and form a pair of ground retention members; wherein there at least two pairs of ground retention members spaced from one another along a length of said middle portion of said spike; and wherein said at least two pairs of ground retention members are oriented 90 degrees to one another in an alternating pattern.

9. The inground anchor of claim 6, wherein said at least one semi-cylindrical clip portion of both of said two clips have an inner diameter chosen from a group of dimensions consisting of ½ inch, ¾ inch, and 1 inch; and wherein said at least one aperture of said panel portion of each of said two wing spikes has an inner diameter chosen from a group of dimensions consisting of ½ inch, ¾ inch, and 1 inch.

10. A watering system comprising:
a plurality of sprinklers;
at least one main water hose;
a plurality of water supply lines; and
a plurality of inground anchors, each comprising:
an elongated body including:
an elongated shaft including:
a proximal end portion;
a middle portion; and
a distal end portion; and
an elongated spike including:
a proximal end portion;
wherein said proximal end portion is attached to said distal end portion of said elongated shaft;
a middle portion; and
a distal end portion;
wherein said elongated spike is tapered from said proximal end portion to said distal end portion;
two clips, each including:
at least one semi-cylindrical clip portion;
wherein said at least one semi-cylindrical clip portion is adapted to releasably retain one of said plurality of sprinklers or water lines therein;
wherein said two clips are attached to opposite sides of said proximal end portion of said elongated body;
two wing spikes, each including:
a panel portion;
wherein said panel portion is attached to said distal end portion of said elongated shaft; and
a downwardly extending tapered ground penetrating portion;
wherein said downwardly extending tapered ground penetrating portion extends from said panel portion and is spaced from said distal end portion of said elongated shaft;
wherein said two wing spikes are attached to opposite sides of said distal end portion of said elongated body; and
at least one ground retention member including:
a panel portion;
wherein said panel portion is attached to said middle portion of said elongated spike; and
an upwardly extending ground engaging tapered portion;
wherein said upwardly extending ground engaging tapered portion extends from said panel portion and is spaced from said middle portion of said elongated spike;
wherein said plurality of inground anchors are each adapted such that when inserted into the ground said elongated spike, said at least one ground retention member, and said ground penetrating portions of said two wing spikes are within and engage the ground to thereby resist removal therefrom or rotation thereto;
wherein a chosen number of said plurality of sprinklers are adapted to be attached to respective semi-cylindrical clip portions of said clips of said plurality of inground anchors; and
wherein said plurality of water supply lines are respectively attached between said at least one main water hose and said plurality of sprinklers and held in place via said plurality of inground anchors, to thereby form said watering system.

11. The watering system of claim 10, wherein said two clips are oriented 180 degrees from one another upon said proximal end portion of said elongated body.

12. The watering system of claim 10, wherein each of said two clips includes two spaced semi-cylindrical clip portions.

13. The watering system of claim 12, wherein said two semi-cylindrical clip portions of each of said two clips are in alignment one another and adapted such that when a water supply line is attached therebetween said two semi-cylindrical clip portions contact the same side of said water supply line.

14. The watering system of claim 12, wherein said two semi-cylindrical clip portions of each of said two clips are oriented 180 degrees from one another and adapted such that when a water supply line is attached therebetween said two semi-cylindrical clip portions contact opposite sides of said water supply line.

15. The watering system of claim 10, wherein said panel portion of each of said two wing spikes includes at least one aperture therethrough adapted to allow a water supply line to pass therethrough and extend upwardly to a respective one of said two clips.

16. The watering system of claim 10, wherein there are at least two ground retention members spaced from one another.

17. The watering system of claim 16, wherein there are two ground retention members spaced from one another and oriented 180 degrees to one another and form a pair of ground retention members; wherein there at least two pairs of ground retention members spaced from one another along a length of said middle portion of said spike; and wherein said at least two pairs of ground retention members are oriented 90 degrees to one another in an alternating pattern.

18. The watering system of claim 15, wherein said at least one semi-cylindrical clip portion of both of said two clips have an inner diameter chosen from a group of dimensions consisting of ½ inch, ¾ inch, and 1 inch; and wherein said at least one aperture of said panel portion of each of said two wing spikes has an inner diameter chosen from a group of dimensions consisting of ½ inch, ¾ inch, and 1 inch.

19. The watering system of claim 10, wherein the outer diameter of said at least one water supply line is chosen from a group of dimensions consisting of ½ inch, ¾ inch, and 1 inch.
